(19) United States
(12) Patent Application Publication
(10) Pub. No.: US 2024/0004955 A1
(43) Pub. Date: Jan. 4, 2024

(54) COMPUTER-IMPLEMENTED MEMORY ALLOCATION METHOD FOR SPARSE MATRIX MULTIPLICATION APPLICATIONS

(71) Applicant: Alibaba (China) Co., Ltd., Hangzhou (CN)

(72) Inventors: Zhaoyang DU, Hangzhou (CN); Yijin GUAN, Beijing (CN); Dimin NIU, Sunnyvale, CA (US); Hongzhong ZHENG, Los Gatos, CA (US)

(21) Appl. No.: 17/984,230

(22) Filed: Nov. 9, 2022

(30) Foreign Application Priority Data
Jun. 29, 2022 (CN) 202210757020.8

(51) Int. Cl. G06F 17/16; G06F 7/487; G06F 9/50

(52) U.S. Cl. CPC G06F 17/16; G06F 7/4876; G06F 9/5016

(57) ABSTRACT

This application describes an accelerator, a computer system, and a method for memory optimization in sparse matrix-matrix multiplications (spGEMM). The memory optimization includes accurate memory pre-allocation for a to-be-generated output matrix of spGEMM between two sparse matrices. An exemplary method may include: sampling a plurality of first rows in the first sparse matrix; identifying, based on indices of non-zero data in the plurality of first rows, a plurality of second rows in a second sparse matrix; performing symbolic multiplication operations between the non-zero data in the plurality of first and second rows; determining an estimated compression ratio of the output matrix; determining an estimated mean row size for each row in the output matrix based on the estimated compression ratio; and allocating, according to the estimated mean row size and a total number of rows of the output matrix, a memory space in a hardware memory.

### CROSS-REFERENCE TO RELATED APPLICATION

This application claims priority to and benefits of Chinese patent Application No. 202210757020.8, filed with the China National Intellectual Property Administration (CNIPA) on Jun. 29, 2022. The entire contents of the above-identified application are incorporated herein by reference.

### TECHNICAL FIELD

The disclosure relates generally to efficient memory allocation for sparse matrix multiplications.

### BACKGROUND

General Sparse Matrix-Matrix Multiplication (spGEMM) has attracted much attention from researchers in the fields of multigrid methods and graph analysis. Many real-world applications involve performing spGEMM on sparse matrices. For example, the publicly available SuiteSparse Matrix Collection is a large and actively growing set of sparse matrices that arise from a wide spectrum of domains, such as semiconductor devices, computer graphics and vision, robotics and kinematics, quantum chemistry, chemical process simulation, and so on.

In computer technologies, sparse matrices are usually stored in a compact format to improve the memory/storage efficiency, such as using Coordinate list (COO), Compressed Sparse Row (CSR), bitmap format, etc. The size of the compact data structure is closely related to the number of non-zero values in the matrix. When generating a new sparse matrix (e.g., as a result of spGEMM operation), allocating a right-size memory space to store the new sparse matrix in the compact data structure is critical for memory efficiency. However, it is difficult to know or predict the accurate size of the output matrix (e.g., the number of non-zero values) before actually performing the matrix multiplication.

### SUMMARY

Various embodiments of the present specification may include hardware circuitries, systems, methods for efficient memory allocation for sparse matrix multiplications.

According to one aspect, a sparse matrix-matrix multiplications (spGEMM) accelerator is described. The accelerator is designed for efficient memory allocation in performing spGEMM between a first sparse matrix and a second sparse matrix. In some embodiments, the accelerator may include sampling circuitry, memory-size estimation circuitry, and memory management circuitry. The sampling circuitry may be configured to sample a plurality of first rows in the first sparse matrix and identify a plurality of second rows in the second sparse matrix based on indices of non-zero data in the plurality of sampled first rows. The memory-size estimation circuitry may be configured to perform symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows, determine an estimated compression ratio of the output matrix based on the sampled NNZ and sampled FLOP; and determine an estimated mean row size for storing non-zero data of each row in the output matrix based at least on the estimated compression ratio and an estimated total number of floating point multiplication operations (overall FLOP). Here, the symbolic multiplication operations may also be referred to as simulated matrix multiplication, which predicts the number of non-zero values (NNZ) in the product based on the index information of non-zero data in the sampled rows and the corresponding rows rather than actually performing floating point multiplications. Subsequently, the memory management circuitry may be configured to allocate, through a system call according to the estimated mean row size and a total number of rows of the output matrix, a memory space in a hardware memory for storing the output matrix before performing the spGEMM between the first sparse matrix and the second sparse matrix.

In some embodiments, the multiplication operations between the non-zero data in the plurality of first rows and non-zero data in the plurality of second rows comprise: a first symbolic multiplication that computes the sampled NNZ in the hypothetical product of the plurality of first rows and the plurality of second rows, and a second symbolic multiplication that computes the sampled FLOP in the hypothetical product of the plurality of first rows and the plurality of second rows, wherein the first symbolic multiplication and the second symbolic multiplication are performed based on index information of the plurality of first rows and the plurality of second rows, and in comparison to the second symbolic multiplication, the first symbolic multiplication comprises an additional column index deduplication step.

In some embodiments, the memory management circuitry may be further configured to: allocate an array of pointers respectively corresponding to the rows of the output matrix, wherein the array of pointers are initialized.

In some embodiments, the memory management circuitry may be further configured to: during spGEMM, detect that the estimated mean row size is insufficient to store non-zero data of a row in the output matrix; dynamically allocate an additional memory space corresponding to the row; and update one of the array of pointers corresponding to the row to point to the dynamically allocated additional memory space.

In some embodiments, the hardware memory includes a random-access memory of a computer system, and the allocating the memory space in a hardware memory according to the estimated mean row size and the total number of rows of the output matrix further includes: scaling up the estimated mean row size by a factor that is greater than one; determining a size of the memory space based on the scaled-up estimated mean row size and the total number of rows of the output matrix; and allocating the memory space based on the determined size from the RAM.

According to another aspect, a computer-implemented method for memory allocation in performing general sparse matrix-matrix multiplications (spGEMM) is described. The method may include: obtaining a first sparse matrix and a second sparse matrix for performing spGEMM between the first sparse matrix and the second sparse matrix; sampling a plurality of first rows in the first sparse matrix; identifying, based on indices of non-zero data in the plurality of first rows, a plurality of second rows in a second sparse matrix; performing symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows; determining an estimated compression ratio of the spGEMM's output matrix based on the sampled NNZ and sampled FLOP; determining an estimated mean row size for storing non-zero data of each row in the output matrix based at least on the estimated compression ratio and an estimated total number of floating point multiplication operations (overall FLOP); and allocating, according to the estimated mean row size, a memory space in a hardware memory for storing the output matrix before performing the spGEMM.

In some embodiments, the performing symbolic multiplication operations between the non-zero data in the plurality of first rows and non-zero data in the plurality of second rows comprises: performing a first symbolic multiplication to obtain the sampled NNZ in the hypothetical product of the plurality of first rows and the plurality of second rows; and performing a second symbolic multiplication to obtain the sampled FLOP in the hypothetical product of the plurality of first rows and the plurality of second rows, wherein the first symbolic multiplication and the second symbolic multiplication are performed based on index information of the plurality of first rows and the plurality of second rows, and in comparison to the second symbolic multiplication, the first symbolic multiplication comprises an additional column index deduplication step.

In some embodiments, the method may further include: allocating an array of pointers respectively corresponding to the rows of the output matrix, wherein the array of pointers are initialized.

In some embodiments, the method may further include: during the spGEMM, detecting that the estimated mean row size is insufficient to store non-zero data of a row in the output matrix; dynamically allocating an additional memory space corresponding to the row; and updating one of the array of pointers corresponding to the row to point to the dynamically allocated additional memory space.

In some embodiments, the method may further include: performing the spGEMM between non-zero data of the first sparse matrix and non-zero data of the second sparse matrix, wherein a multiplication between a first non-zero data from the first sparse matrix and a second non-zero data from the second sparse matrix generates one output value; determining a memory location in the allocated memory space for storing the output value based on indices of the first non-zero data and the second non-zero data; and storing the output value in the allocated memory space at the determined memory location.

In some embodiments, the determining the memory location for storing the output value includes: determining a row index of the output value based on a row index of the first non-zero data; determining a column index of the output value based on a column index of the second non-zero data; and determining the memory location based on the row index of the output value and the column index of the output value.

In some embodiments, the identifying the plurality of second rows in the second sparse matrix based on indices of the non-zero data in the plurality of first rows includes: for each of the non-zero data in the plurality of first rows, identifying a second row in the second sparse matrix with a row index equal to a column index of the each non-zero data.

In some embodiments, the obtaining the first sparse matrix and the second sparse matrix includes: reading non-zero data of the first sparse matrix and the second sparse matrix stored in a compressed sparse row (CSR) format.

In some embodiments, the performing the first symbolic multiplication to obtain the sampled NNZ comprises: for each first row in the plurality of first rows, retrieving index information of non-zero data in one or more of the plurality of second rows that correspond to the first row; iterating column indices of the non-zero data in one or more second rows based on the retrieved index information; inputting the column indices into a data structure for detecting duplicated column indices and obtaining a number of unique column indices; and accumulating the number of unique column indices to obtain the sampled NNZ.

In some embodiments, the performing the second symbolic multiplication to obtain the sampled FLOP comprises: for each first row in the plurality of first rows, retrieving index information of non-zero data in one or more of the plurality of second rows that correspond to the first row; determining a number of indices in the one or more second rows based on the index information, wherein each of the indices corresponds to a non-zero data; and accumulating the number of indices to obtain the sampled FLOP.

In some embodiments, the determining the estimated mean row size for storing each row of the output matrix includes: performing a symbolic multiplication between the first sparse matrix and the second sparse matrix to estimate a total number of floating point multiplication operations (overall FLOP) based on index information of the first sparse matrix and the second sparse matrix; determining a number of rows of the output matrix; determining the estimated mean row size for storing each row of the output matrix based on (1) the overall FLOP, (2) the number of rows of the output matrix, and (3) the estimated compression ratio.

According to yet another aspect, a non-transitory computer-readable storage medium for memory allocation in executing sparse matrix-matrix multiplications (spGEMM) between a first sparse matrix and a second sparse matrix is described. The storage medium stores instructions that, when executed by one or more processors, cause the one or more processors to perform operations including: obtaining a first sparse matrix and a second sparse matrix for performing spGEMM between the first sparse matrix and the second sparse matrix; sampling a plurality of first rows in the first sparse matrix; identifying, based on indices of non-zero data in the plurality of first rows, a plurality of second rows in a second sparse matrix; performing symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows; determining an estimated compression ratio of the spGEMM's output matrix based on the sampled NNZ and sampled FLOP; determining an estimated mean row size for storing non-zero data of each row in the output matrix based at least on the estimated compression ratio and an estimated total number of floating point multiplication operations (overall FLOP); and allocating, according to the estimated mean row size, a memory space in a hardware memory for storing the output matrix before performing the spGEMM.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates an exemplary schematic diagram of a hardware environment for implementing efficient memory allocation for spGEMM (General Sparse matrix-matrix Multiplication) in accordance with some embodiments.

FIG. 2 illustrates an exemplary row-based approach for executing spGEMM with efficient memory allocation in accordance with some embodiments.

FIG. 3A illustrates an exemplary block diagram of efficient memory allocation for spGEMM in accordance with some embodiments.

FIG. 3B illustrates two different symbolic multiplication operations for estimating compression ratio in accordance with some embodiments.

FIG. 4 illustrates an exemplary memory layout of efficient memory allocation for executing spGEMM in accordance with some embodiments.

FIG. 5 illustrates an exemplary workflow of allocating memory space for executing spGEMM in accordance with some embodiments.

FIG. 6 illustrates an exemplary method of efficient memory allocation for spGEMM in accordance with some embodiments.

FIG. 7 illustrates an exemplary block diagram of a hardware device with built-in efficient memory allocation for spGEMM in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In sparse matrices, typically, the number of non-zero (NNZ) elements is much smaller than the number of zero elements. When storing sparse matrices in computer systems, compact data structures are often used to save the memory footprint of the matrices. These data structures may include Coordinate list (COO), Compressed Sparse Row (CSR), bit map, etc. General sparse matrix-matrix multiplication (spGEMM), involving multiplying two sparse matrices, is a fundamental and expensive computational kernel in numerous scientific computing applications and graph algorithms, such as algebraic multigrid solvers, triangle counting, multi-source breadth-first searching, and so on.

There are several challenging problems associated with optimizing the execution of spGEMM on computer systems, one of which is the unknown number of non-zeros in the output matrix of the spGEMM. An accurate estimation of the number of non-zeros in the output matrix is critical for optimizing the execution performance of spGEMM and allocating hardware resources, including memory resources, for performing spGEMM. For example, with the accurate estimation, a more precise memory space may be pre-allocated for the output matrix before actually performing the spGEMM. The memory pre-allocation reduces, minimizes or avoids the cost of dynamic memory allocation for each new non-zero element generated from the spGEMM. On the other hand, excessively over-allocated memory space may cause memory waste and overall system pressure, and under-allocated memory space may lead to a large number of expensive dynamic memory allocations for the generated non-zero elements.

There are several solutions for estimating the number of non-zeros of the output matrix in spGEMM involving two input sparse matrices. For example, a precise method determines the actual size of the output. The precise method typically includes two phases: symbolic phase and numeric phase. In the symbolic phase, the precise number of non-zeros in the output matrix is computed, while the real values are calculated in the numeric phase. This precise method is computationally expensive because of the non-trivial pre-computation of the actual number of non-zeros. As another example, an upper bound method computes an upper bound of the number of non-zeros in the output matrix. One of the method for calculating an upper bound is to count the number of non-zeros of the corresponding row in one input matrix for each non-zero in the other input matrix. This upper bound method alone usually yields poor performance (e.g., extremely high memory consumption) for applications with a high compression ratio. Here, the “compression ratio” refers to a ratio between a number of multiplication operations to generate the output matrix and a number of non-zero elements in the generated output matrix. In many real-world applications, the non-zero elements in a sparse matrix may be irregularly generated. For example, a social media may be represented as a graph, which may be stored as a sparse matrix. Each value within the matrix may represent a connection strength between two users. The connection strength between any given two users may evolve (e.g., increase or decrease) because of user actions (e.g., following each other, adding mutual friends). Each user action may have different contributions to the connection strength between the two users. That is, there may be multiple values with the same row/column index pairs. These duplicated values/entries may significantly deteriorate the accuracy of the upper bound method. Other methods such as progressive method may by themselves suffer poor performance due to frequent (dynamic) memory allocations.

To address the above-identified deficiencies of existing solutions, the present disclosure describes hybrid memory allocation methods and hardware devices to more accurately estimate the memory footprint of the output matrix without expensive computational cost. This hybrid memory allocation may include a memory pre-allocation phase and an optional memory dynamic-allocation phase. For easy understanding, several terms used in the following description are defined here.

FLOP may refer to the number of floating-point multiplication operations to compute an output matrix or a row of the output matrix. In this disclosure, floating-point multiplication is used as an example. In some embodiments, the multiplication operations may be based on integers or other types of data.

FLOPR may refer to the number of floating-point multiplication operations to compute a row of the output matrix.

NNZ may refer to the number of non-zero elements of a matrix or a row of a matrix.

NNZR may refer to the number of non-zero elements of a row of a matrix.

Compression Ratio (CR) may refer to FLOP/NNZ of the output matrix or a row of the output matrix.

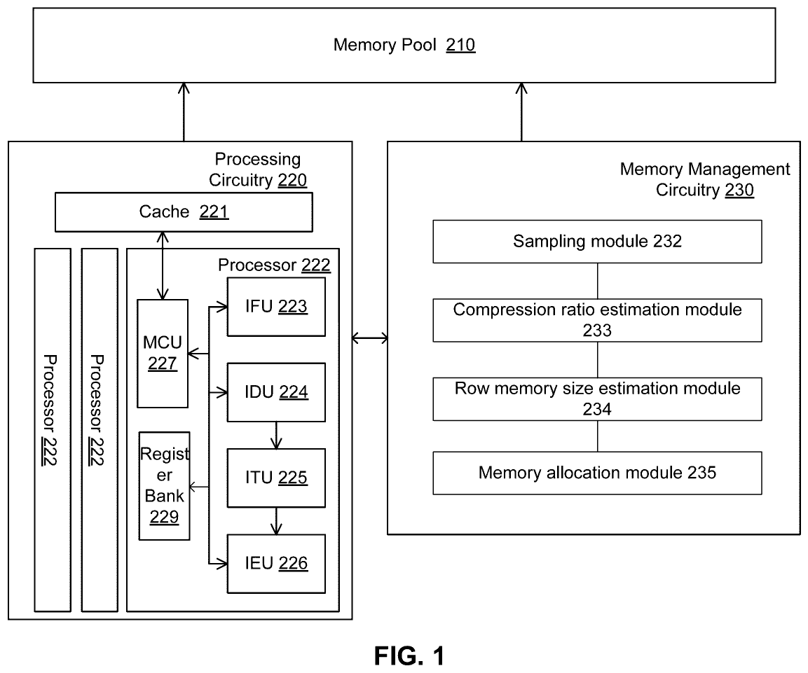

FIG. 1 illustrates an example schematic diagram of a hardware environment for implementing efficient memory allocation for spGEMM (General Sparse matrix-matrix Multiplication) in accordance with some embodiments.

As shown, the hardware environment in FIG. 1 includes a memory pool 210, a processing circuitry 220, and a memory management circuitry 230. The layout of the components in the hardware environment is for illustrative purposes, and may be implemented in different ways depending on the actual hardware configuration. In some embodiments, the memory management circuitry 230 may be implemented as a standalone hardware accelerator that is separated from the processing circuitry 220 (e.g., one or more CPUs or GPUs). In some embodiments, the memory management circuitry 230 may be implemented as a part of the processing circuitry 220 (e.g., a part of one or more CPUs or GPUs) to improve the efficiency of memory management. The memory pool 210 may refer to external storage devices, system RAM, other types of memory resources, or any combination thereof.

In some embodiments, the processing circuitry 220 may include one or more processors 222 and a cache 221 shared by the one or more processors 222. Each processor 222 may include an instruction fetching unit (IFU) 223, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory pool 210 to a register bank 229. In some embodiments, the to-be-executed instructions or data can be fetched into the cache 221 and sent to the IFU 223 via microcontroller unit (MCU) 227. After obtaining the instructions or data, the processing circuitry 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured to receive the decoded instructions from the IDU 224 and perform instruction scheduling and management. It may efficiently allocate instructions to different IEUs 226 for parallel processing. In some embodiments, after the ITU 225 allocates an instruction to one IEU 226, the IEU 226 may execute the instruction.

In some embodiments, the memory management circuitry 230 may receive instructions from processing circuitry 220, access data from the memory pool 210, and perform local computations such as determining an estimated size of memory space for storing an output matrix of spGEMM. The memory management circuitry 230 may send the estimated size back to the processing circuitry 220 for actually applying or allocating the memory space, or trigger system calls to allocate the memory space accordingly.

In some embodiments, the memory management circuitry 230 may include an obtaining module, a sampling module 232, a compression ratio estimation module 233, a row memory size estimation module 234, and a memory application module 235. These modules may be implemented as electronic circuits including electronic components such as resistors, transistors, capacitors, inductors, and diodes, connected by conductive wires or traces through which electric current can flow. In other embodiments, these modules may be implemented by software controlling the data logic and flow among the electronic components. The modules in FIG. 1 are for illustrative purposes. Depending on the implementation, the memory management circuitry 230 may include fewer, more, or alternative modules.

The obtaining module may be configured to obtain the two sparse matrices for spGEMM. For example, the non-zero elements in the two sparse matrices may be obtained from a storage place (e.g., a database storing the sparse matrices in a compact form). In some embodiments, each non-zero element may include a non-zero value and be associated with a row-column index pair (a row index and a column index may locate the non-zero value within the corresponding matrix). In some embodiments, only the non-zero elements of the sparse matrices are stored and the zero elements are ignored. The non-zero elements may be stored in a way that the corresponding index information are explicitly or implicitly stored along with the non-zero values.

The sampling module 232 may be configured to sample a subset of the rows of a first sparse matrix (a first input matrix for spGEMM). In some embodiments, this sampling step may include: identifying rows with at least one non-zero element, and sampling from the identified rows. This is because rows with all zeros may not provide useful information for estimating the NNZ in the output matrix. For each of the sampled rows from the first sparse matrix, there may be one or more non-zero elements. For each of the non-zero elements from a sampled row, a corresponding row from the second sparse matrix may be identified based on the column index of the non-zero element from the sampled row. For instance, if row 0 of the first sparse matrix includes two non-zero elements at row-column indices (0, 128) and (0, 256), the corresponding rows from the second sparse matrix are rows 128 and 256.

Subsequently, a symbolic multiplication may be performed between the sampled rows from the first sparse matrix and the corresponding rows from the second sparse matrix to predict a number of non-zero data (NNZ) in a hypothetical product of multiplying the sampled rows and the corresponding rows. The symbolic multiplication may also be referred to as a simulated multiplication because it does not actually perform floating point multiplications between the actual non-zero floating point numbers. Instead, the symbolic multiplication predicts the NNZ based on the index information of non-zero data in the sampled rows and the corresponding rows, without actually computing the products. The symbolic multiplication effectively avoids performing expensive floating point multiplication that generates the actual product (performing the actual multiplications require more CPU cycles in comparison to simply iterating the values stored in memory).

The compression ratio estimation module 233 may be configured to estimate the row size (the number of non-zero elements in each row) of the output matrix based on the NNZ predicted by the symbolic multiplication operations between the sampled rows from the first sparse matrix and the corresponding rows from the second sparse matrix of the spGEMM. In some embodiments, the compression ratio of the output matrix may be estimated based on (1) a total number of floating point multiplication operations (FLOP) calculated by a second version of symbolic multiplication based on row sizes of the sampled rows from the first sparse matrix and the corresponding rows from the second sparse matrix and (2) the NNZ calculated by the first version symbolic multiplication of the sampled rows from the first sparse matrix and the corresponding rows from the second sparse matrix. For instance, the ratio between the FLOP and the NNZ may be calculated and referred to as the estimated compression ratio of the output matrix.

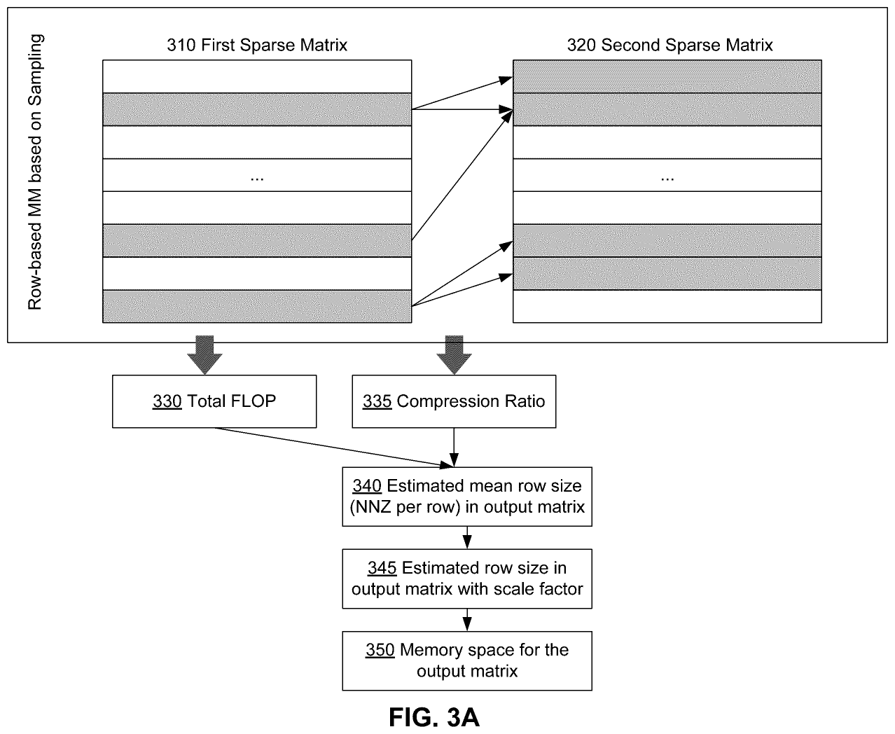

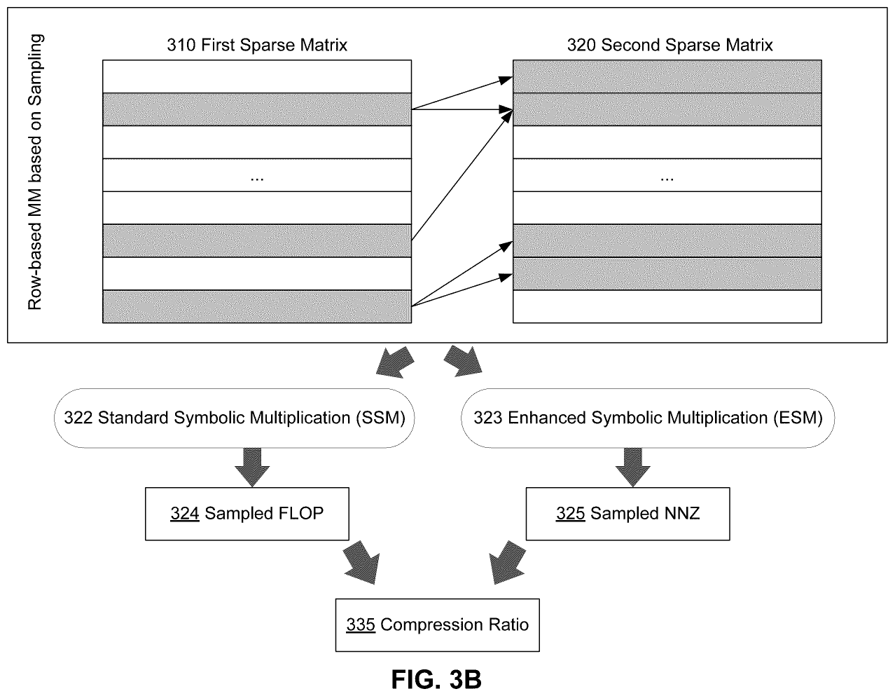

Both the symbolic multiplication for computing FLOP (also referred to as a Standard Symbolic multiplication (SSM)) and the symbolic multiplication for computing NNZ (also referred to as an Enhanced Symbolic multiplication (ESM)) are symbolic computations, which avoids actually computing the products of floating numbers. These symbolic computations greatly save the computing resources in estimating the size of the output matrix for spGEMM and improve the overall system efficiency. On the other hand, ESM and SSM are different in terms of their respective algorithms. The differences between SSM and ESM are further illustrated in FIG. 3B and corresponding descriptions.

In some cases, it is possible that the NNZ predicted by the symbolic multiplication is not perfectly accurate, and the inaccurate NNZ may negatively affect the accuracy of the estimated compression ratio. For instance, multiple partial products generated by non-zero data may cancel each other when being aggregated and thus generate a zero-value output. In most of the practical applications, the probability of the above scenario is negligible. However, if the chance of aggregating multiple non-zero partial product into a zero-value output is greater than a threshold in a certain application field, the symbolic multiplication may over-estimate the NNZ, and thus underestimate the compression ratio and cause over-allocating the memory space. In these cases, the symbolic multiplication may be replaced with numeric matrix multiplication with floating point multiplication to generate the actual product.

The row memory size estimation module 234 may be configured to estimate the size of memory that each row of the output matrix may take, i.e., the size of memory to store all non-zero elements in each row of the output matrix before executing the spGEMM. The estimation process may be based on the estimated compression ratio generated by the compression ratio estimation module 233. The underlying assumption here is that the estimated compression ratio determined based on the data sampled from the original input matrices (e.g., the sampled rows and the corresponding rows) would be similar to the compression ratio in the multiplication of the original input matrices.

In some embodiments, the row memory size estimation module 234 may first compute the overall FLOP between the first input matrix and the second input matrix. Note that this overall FLOP is computed based on the entire input matrices, whereas the FLOP for computing estimated compression ratio is computed based on the sampled rows from the first input matrix and the corresponding rows in the second input matrix. The overall FLOP may be computed using the SSM algorithm described above, but based on (1) index information of all rows of the first matrix, and (2) row size of all the corresponding rows of the second matrix. Here, the “row size” refers to the number of non-zero data in the row.

With the estimated compression ratio and the overall FLOP, in some embodiments, the row memory size estimation module 234 may then compute the number of non-zero values in each row of the to-be-generated output matrix using the following formula: FLOP/M/compression_ratio*s, where M represents the number of rows in the first input matrix, s represents a scale factor that is greater than one. According to empirical data, the average number of non-zero values in the sparse output matrices (e.g., matrices generated by spGEMM computations) are usually consistent across the rows with marginal fluctuation.

The memory allocation module 235 may be configured to allocate memory spaces for the output matrix of a spGEMM according to the estimated row memory size (also called estimated mean row size) from the row-memory size estimation module 234. This allocation may be deemed as a pre-allocation before the spGEMM is actually executed. The memory space allocated may be a contiguous section of a hardware memory device for efficient sequential data access. In a logical view, the memory space allocated may include a plurality of equal-sized memory sections corresponding to the plurality of rows of the output matrix. The number of rows of the output matrix may be equal to the first input matrix of the spGEMM. In some embodiments, a scale factor may be applied to the estimated number of non-zero values in each row of the output matrix. This scale factor may help reduce the chance of a row growing beyond the allowed memory size during runtime. Since the FLOP/M/compression_ratio represents an average NNZ of the rows in the output matrix, it is likely that some rows may go beyond this average NNZ when the multiplication is actually executed (runtime). Thus, the scale factor may help expand the estimated row memory size to cover more rows in the output matrix. In some embodiments, this scale factor is a floating number greater than one e.g., 1.5. In some embodiments, based on the estimated number of non-zero values in each row and the physical size of each non-zero values (e.g., the number of bytes representing each non-zero value), an estimated row memory size may be determined.

In some embodiments, even though the NNZ of the rows of the output matrix is usually consistent, it is possible that some rows may go beyond the estimated row memory size (even with the scale factor). In these cases, additional memory space may be dynamically allocated for these rows. For example, after the pre-allocation of the memory space, a plurality of pointers (e.g., NULL pointers) may be created for the plurality of rows of the output matrix. During the execution of the spGEMM, if any of the rows in the output matrix needs additional memory space, the pointer corresponding to the row may be redirected or updated to a memory space dynamically allocated for that row. This process may be referred to as a runtime-allocation in addition to the above-described pre-allocation. In some embodiments, the runtime-allocation may be element-based or chunk-based. With the element-based approach, a new memory space is dynamically allocated for each extra non-zero element generated, and the new memory space fits the newly generated element. With the chunk-based approach, when an extra non-zero element is generated, a chunk of memory space is dynamically allocated to fit more than just the newly generated element. These two approaches have different tradeoffs between memory allocation accuracy and memory allocation efficiency. The size of the chunk may be predetermined or dynamically changing. For example, every allocation may double the size of the chunk.

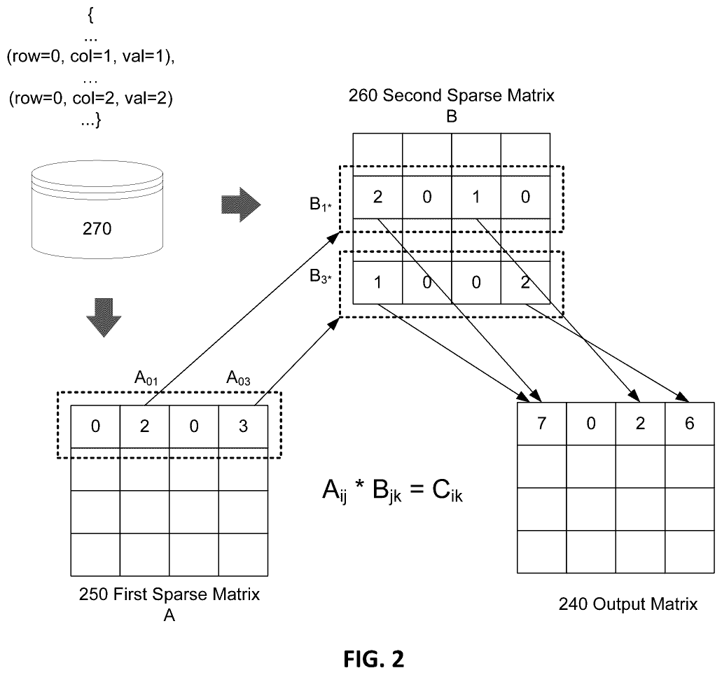

FIG. 2 illustrates an exemplary row-based approach for executing spGEMM with efficient memory allocation in accordance with some embodiments. In some embodiments, the memory management circuitry in FIG. 1 relies on row-based matrix multiplications, which is an approach that is different from a textbook row-column matrix multiplication.

As shown in FIG. 2, the spGEMM involves two sparse input matrices A 250 and B 260. These sparse matrices may be stored in a data repository 270 (e.g., a database, a cloud server) in a compact storage format, such as COO, CSR, bit maps, etc. These compact storage formats may only store the non-zero elements in the sparse matrices (along with their index information) to save storage space and facilitate access to non-zero elements. In some practical applications, the non-zero elements generated as part of the spGEMM using row-based matrix multiplication may include a plurality of duplicated data entries. The term “duplicated data entries” refers to multiple values corresponding to the same row index and column index (also called a row-column index pair) in the output matrix and need to be aggregated to generate one output value.

In some embodiments, while reading the non-zero elements from the data repository 270, an iterative process of row-based matrix multiplication may be performed. For example, the first row (row=0) of the first sparse matrix A 250 in FIG. 2 may include multiple non-zero elements (e.g., Aₒ₁ and A₀₃ at column 1 and 3, respectively). For each of these non-zero elements, a corresponding row of the second sparse matrix B 260 may be obtained. The corresponding row from B may have a row index equal to the column index of the non-zero element. For instance, Aₒ₁ corresponds to row B_{1*} of matrix B. The non-zero element from matrix A then may multiply with all non-zero elements in the corresponding row from B. For each multiplication between the element at (row=i, col j) of matrix A and the element at (row j, col=k) of matrix B, the resulting output value may be placed at a position (row=i, col=k) of an output matrix 240. This principle may be denoted as Aᵢⱼ*Bⱼₖ=Cᵢₖ. After processing all of the non-zero elements in the first row of matrix A, the next row of matrix A may be processed. In some embodiments, since the rows of the matrix A in the row-based matrix multiplication may be processed independently, parallel processing techniques may be applied to improve the computation efficiency. When multiple processes are writing multiplication results into the same cell in the output matrix 240, these writes may be serialized using locking mechanisms.

With the above description, the difference between the textbook row-column matrix multiplication and the row-based matrix multiplication becomes obvious. In the textbook row-column matrix multiplication, a row from a first matrix is multiplied with a corresponding column from a second matrix, and the multiplication results may be summed up to generate one output value in an output matrix. That is, in the textbook row-column matrix multiplication, each multiplication operation in one execution cycle will generate one final output value for the output matrix. In contrast, row-based approach involves multiplying a first row from the first matrix and a plurality of corresponding second rows from the second matrix in a plurality of execution cycles. Each multiplication between the first row and each second row may generate one or more partial output values for a row of the output matrix. These partial output values generated from the plurality of multiplications during the plurality of execution cycles may be aggregated to generate the final output values for the row of the output value. In other words, row-based matrix multiplication imposes new challenges that may not exist in traditional row-column matrix multiplication: the partial output values generated from different execution cycles may contribute to the same output value in the output matrix. These partial outputs may be referred to as duplicate outputs with the same row-column index pair in the output matrix.

FIG. 3A illustrates an exemplary block diagram of efficient memory allocation for spGEMM in accordance with some embodiments. The diagram in FIG. 3A illustrates the efficient memory allocation described in FIG. 1 applied to a row-based spGEMM using sampling.

In spGEMM, a first sparse matrix 310 and a second sparse matrix 320 may need to be multiplied to generate an output matrix. In some embodiments, the size of the output matrix may be estimated based on (1) sampling rows from the first sparse matrix 310, (2) performing two versions of symbolic computations using the sampled rows and the corresponding rows from the second sparse matrix 320 to obtain a sampled FLOP and a sampled NNZ, respectively, and (3) determining an estimated compression ratio of the to-be-generated output matrix based on the sampled FLOP and sampled NNZ.

As shown in FIG. 3, the grey rows in the first sparse matrix 310 may represent the sampled rows, and the grey rows in the second sparse matrix 320 may represent the rows that are corresponding to the sampled rows. The correspondence between the grey rows from the two matrices is represented with arrows. It may be noted that two different sampled rows from the first sparse matrix 310 may be mapped to the same row from the second sparse matrix 320.

After obtaining the sampled rows from the first sparse matrix 310 and the corresponding rows from the second sparse matrix 320, two different versions of symbolic multiplications may be performed based on the distribution of the non-zero elements (e.g., the sparsity patterns) in the sampled rows and the corresponding rows to obtain the sampled FLOP (an estimated number of multiplication operations to be performed in multiplying the sampled rows and the corresponding rows) and the sampled NNZ (an estimated number of non-zero output to be generated after multiplying the sampled rows and the corresponding rows). These symbolic multiplications may include SSM for determining the sampled FLOP and ESM for determining the sampled NNZ. Based on the sampled FLOP and the sampled NNZ, an estimated compression ratio 335 (also called sampled compression ratio) of the output matrix may be determined as FLOP/NNZ.

According to empirical data learned from spGEMM in several practical applications, when the number of sampled rows reaches two hundreds or beyond, the estimated compression ratio 335 of the output matrix is reasonably accurate. In some embodiments, the estimated compression ratio 335 and a total FLOP 330 between the first sparse matrix 310 and the second sparse matrix 320 may be used to determine a total number of non-zero elements in the output matrix. In some embodiments, the total FLOP 330 may be obtained based on (1) index information of all the rows of the first sparse matrix 310, and (2) row sizes of all the corresponding rows of the second sparse matrix 320. Here, “row size” of a row refers to a number of non-zero data in that row. For instance, the total FLOP 330 may be obtained by: for each first row of the first matrix 310, determining column indices of all non-zero elements within the first row; identifying second rows of the second matrix 320 that correspond to the first row, the second rows having row indices equal to the column indices of all non-zero elements within the first row; determining a number of non-zero elements in the second rows; and accumulating the determined number for all rows of the first matrix. The final accumulated number may be used as the total FLOP 330.

With the total FLOP 330 and the estimated compression ratio 335, the total number of non-zero elements (total NNZ) in the output matrix may be determined by FLOP/estimated compression ratio. The number of rows of the output matrix may be determined as equal to the number of rows in the first sparse matrix 310. Based on the total NNZ and the number of rows, an estimated mean row-size 340 of the output matrix may be determined to represent the number of non-zero elements per row in the output matrix.

In some embodiments, the estimated mean row-size 340 may be scaled up by a factor that is greater than one to obtain an estimated row size in the output matrix 345. The factor may be a floating number greater than one. The scaling up is to further reduce the chance that the estimated mean row-size 340 is smaller than the actual row-size (in which case dynamic memory allocation may be required).

Subsequently, a memory space 350 may be allocated to store the not-yet-computed output matrix 345 according to the scaled up row-size. For instance, if a non-zero element in the output matrix includes two 4 bytes indices and one 8 bytes floating number, and each row is estimated (after being scaled up) to have a thousand non-zero elements, each row may take about 12 KB memory size. Assuming the number of rows of the output matrix is about a thousand, the total memory space may be determined as 12 MB.

FIG. 3B illustrates two different symbolic multiplication operations (SSM and (ESM) for estimating compression ratio in accordance with some embodiments. As described above, the estimated compression ratio 335 may be computed based on a sampled FLOP 324 and a sampled NNZ 325, which are respectively computed by using a standard symbolic multiplication (SSM) algorithm 322 and an enhanced symbolic multiplication algorithm (ESM) 323 based on the sampled rows from the first sparse matrix 310 and the corresponding rows from the second sparse matrix 320. In computing the sampled FLOP 324 and NNZ 325, both SSM 322 and ESM 323 avoid performing floating number multiplications and thus greatly save computing resources such as CPU cycles. Furthermore, both SSM 322 and ESM 323 work only on index information of the sampled rows and the corresponding rows rather than the actual non-zero floating-point values, which effectively reduces the volume of data to be read into the memory and processed. Therefore, SSM 322 and ESM 323 may save both computing resources and memory consumption in computing the sampled FLOP and NNZ in comparison to using numeric matrix multiplications to do so.

In some embodiments, after determining the corresponding rows from the second sparse matrix 320 that correspond to the sampled rows from the first sparse matrix 310, both ESM 323 and SSM 322 may be executed by only relying on (1) the row indices of the sampled rows and (2) the column indices of the non-zero data in the plurality of corresponding rows. In some embodiments, ESM 323 may start with, for each sampled row, retrieving index information of non-zero data in one or more corresponding rows (the rows from the second sparse matrix 320 that correspond to the sampled row). Here, the index information of the corresponding rows may be conveniently read from the CSR format of the second sparse matrix 320. The index information to be read from the CSR format may be further trimmed to just the column indices of the non-zero data. ESM 323 may then iterate through the column indices of the non-zero data and input the column indices into a data structure for detecting and removing duplicated values. The data structure may refer to set, list, hash table, hash list, or another suitable data structure depending on the implementation. With the data structure, ESM 323 may determine a number of unique column indices from the column indices of the non-zero data in the one or more corresponding rows. The above steps may be repeated until all sampled rows are processed. The number of unique column indices determined for each sampled row may be accumulated to obtain the sampled NNZ 325.

In some embodiments, SSM 322 may be a simplified version of ESM 323 by skipping the column index deduplication step. For instance, SSM 322 may include: for each sampled row, retrieving index information of non-zero data in one or more corresponding rows (the rows from the second sparse matrix 320 that correspond to the sampled row), and determining a number of non-zero data in the one or more corresponding rows based on the index information (each of the indices corresponding to a non-zero value). This determined number of non-zero data may be accumulated. The above steps may be repeated until all sampled rows are processed. The final accumulated number may be referred to as the sampled FLOP 324.

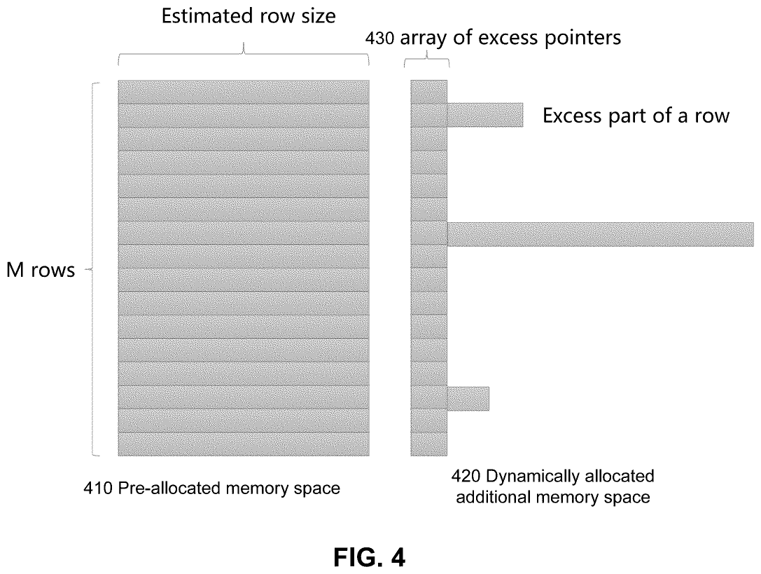

FIG. 4 illustrates an exemplary memory layout of efficient memory allocation for executing spGEMM in accordance with some embodiments. The sampling-based output matrix size estimation described in FIG. 3 may be used to pre-allocate a memory space 410 for the output matrix before performing the spGEMM. In some embodiments, the pre-allocated memory space 410 includes equal-sized memory sections corresponding to the rows of the output matrix. In some cases, the pre-allocated memory sections for some rows may not be sufficient to hold all non-zero elements of these rows. To address this issue, a runtime memory application may be performed just for these rows.

In some embodiments, as part of the pre-allocation of the memory space 410 for the output matrix, an array of excess pointers 430 may be created. In some embodiments, the array of excess pointers 430 are initialized as null pointer. The pointers in the array 430 may respectively correspond to the plurality of rows of the output matrix. During the execution of the spGEMM, if a newly generated non-zero output element goes beyond the pre-allocated memory section for a row, a new memory space 420 may be dynamically allocated, and the pointer corresponding to the row may be redirected or updated to the allocated new memory space 420. That is, in addition to the pre-allocated memory space 410, certain rows may be extended with “on-demand” memory space allocated during runtime. In some embodiments, the new memory space 420 may be allocated on a per-element basis (the size of memory allocated each time may fit one non-zero element) or on a chunk basis (the size of memory allocated each time may fit multiple non-zero elements). The chunk size may be static (e.g., predetermined) or dynamic. For example, for each row, the chunk size may start with a predetermined value, and may be scaled up whenever additional space is required.

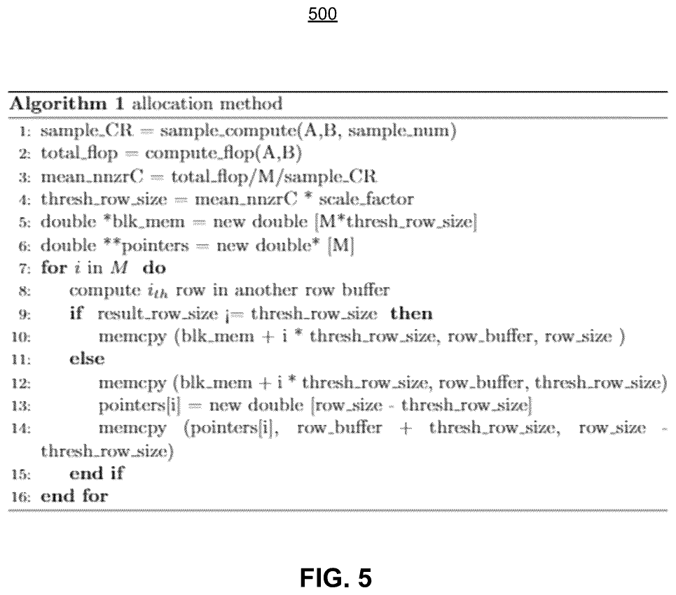

FIG. 5 illustrates an exemplary workflow 500 of allocating memory space for executing spGEMM in accordance with some embodiments. The workflow 500 is represented using a piece of pseudo-code titled “Algorithm 1.” The steps in the workflow 500 are for illustrative purposes, which may include fewer, more, or alternative steps. Some of the steps in the workflow 500 may be executed in different orders or parallel.

The function “sample_compute” in Algorithm 1 generates the sampled compression ratio (e.g., sample_CR) based on sampled rows from matrix A and corresponding rows from matrix B using row-based matrix multiplication. The function compute_flop in Algorithm 1 refers to the symbolic computation of the total FLOP between matrix A and matrix B. Subsequently, a mean NNZR (e.g., a mean number of non-zero values in each row) may be obtained.

In some embodiments, to reduce the chance of run-time memory allocation described in FIG. 5, the mean NNZR may be scaled up using a scale factor (e.g., if the scale factor is 1.5, the pre-allocated memory space may be 1.5 times of (the number of rows times the estimated mean NNZR)).

With the memory space allocated (denoted as blk_mem in Algorithm 1), the spGEMM between matrix A and matrix B may be executed and the generated output values may be stored in the allocated memory space. In some embodiments, the spGEMM may be executed on a row basis, in which each row of the first matrix may be computed against the second matrix. The computation of each row from the first matrix may occur in the system buffer. In some embodiments, if the result row size of the computation is smaller than the estimated row size, the non-zero elements in the result row may be copied from the system memory to the pre-allocated memory section corresponding to the row. If the result row size of the computation is beyond the estimated row size, a new memory space may be allocated based on the difference between the result row size and the estimated row size. The non-zero elements in the result row may first be copied to the pre-allocated memory space, and the rest of the non-zero elements in the result row may be copied to the newly allocated memory space.

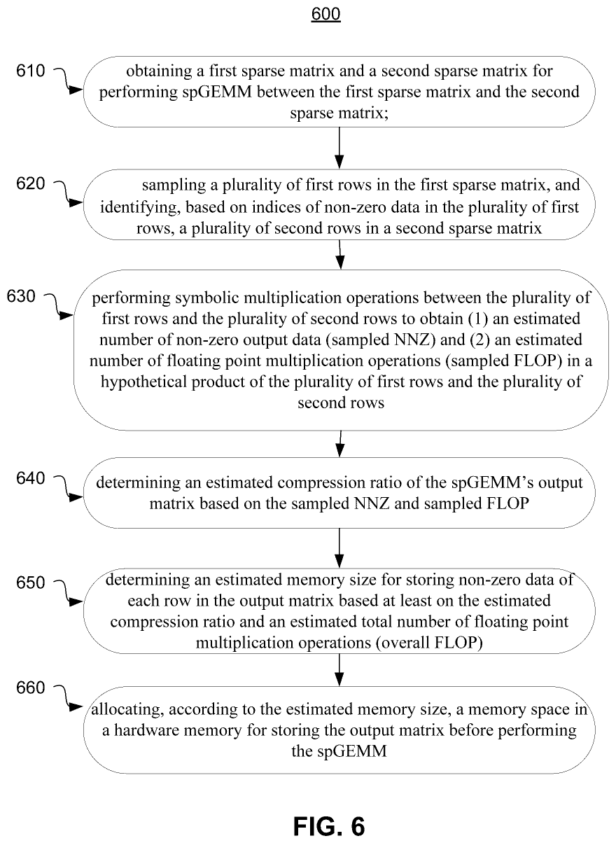

FIG. 6 illustrates an exemplary method 600 of efficient memory allocation for spGEMM in accordance with some embodiments. The method 600 may be implemented in an environment shown in FIG. 1. The method 600 may be performed by a device, apparatus, or system illustrated by FIGS. 1-5, such as the memory management circuitry 230 in FIG. 1. Depending on the implementation, the method 600 may include additional, fewer, or alternative steps performed in various orders or parallel.

Block 610 includes obtaining a first sparse matrix and a second sparse matrix for performing spGEMM between the first sparse matrix and the second sparse matrix. In some embodiments, the obtaining the first sparse matrix and the second sparse matrix comprises: reading non-zero data of the first and second sparse matrix stored in a CSR format.

Block 620 includes sampling a plurality of first rows in the first sparse matrix, and identifying, based on indices of non-zero data in the plurality of first rows, a plurality of second rows in a second sparse matrix. In some embodiments, the identifying the plurality of second rows in the second sparse matrix based on indices of the non-zero data in the plurality of first rows comprises: for each of the non-zero data in the plurality of first rows, identifying a second row in the second sparse matrix with a row index equal to a column index of the each non-zero data.

Block 630 includes performing symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows. In some embodiments, the performing symbolic multiplication operations between the non-zero data in the plurality of first rows and non-zero data in the plurality of second rows comprises: performing a first symbolic multiplication to obtain the sampled NNZ in the hypothetical product of the plurality of first rows and the plurality of second rows; and performing a second symbolic multiplication to obtain the sampled FLOP in the hypothetical product of the plurality of first rows and the plurality of second rows, wherein the first symbolic multiplication and the second symbolic multiplication are performed based on index information of the plurality of first rows and the plurality of second rows, and in comparison to the second symbolic multiplication, the first symbolic multiplication comprises an additional column index deduplication step. In some embodiments, the performing the first symbolic multiplication to obtain the sampled NNZ comprises: for each first row in the plurality of first rows, retrieving index information of non-zero data in one or more of the plurality of second rows that correspond to the first row; iterating column indices of the non-zero data in one or more second rows based on the retrieved index information; inputting the column indices into a data structure for detecting duplicated column indices and obtaining a number of unique column indices; and accumulating the number of unique column indices to obtain the sampled NNZ. In some embodiments, the performing the second symbolic multiplication to obtain the sampled FLOP comprises: for each first row in the plurality of first rows, retrieving index information of non-zero data in one or more of the plurality of second rows that correspond to the first row; determining a number of indices in the one or more second rows based on the index information, wherein each of the indices corresponds to a non-zero data; and accumulating the number of indices to obtain the sampled FLOP.

Block 640 includes determining an estimated compression ratio of the spGEMM's output matrix based on the multiplication operations. In some embodiments, the determining the estimated compression ratio of the output matrix based on the multiplication operations comprises: determining a total number of floating point multiplication operations (FLOP) based at least on row sizes of the plurality of first rows and the plurality of second rows; and determining the estimated compression ratio based on the FLOP and the NNZ.

Block 650 includes determining an estimated mean row size for storing non-zero data of each row in the output matrix based at least on the estimated compression ratio and an estimated total number of floating point multiplication operations (overall FLOP). In some embodiments, the determining the estimated mean row size for storing each row of the output matrix comprises: performing a symbolic multiplication between the first sparse matrix and the second sparse matrix to obtain the overall FLOP based on index information of the first sparse matrix and the second sparse matrix; determining a number of rows of the output matrix; determining the estimated mean row size for storing each row of the output matrix based on (1) the overall FLOP, (2) the number of rows of the output matrix, and (3) the estimated compression ratio.

Block 660 includes allocating, through a system call according to the estimated mean row size and a total number of rows of the output matrix, a memory space in a hardware memory for storing the output matrix before performing the spGEMM between the first sparse matrix and the second sparse matrix.

In some embodiments, the first sparse matrix, the second sparse matrix, and the output matrix are stored using a data structure that stores the non-zero data and excludes zero data. In some embodiments, the hardware memory comprises a random-access memory of a computer system, and the allocating the memory space in a hardware memory according to the estimated mean row size and the total number of rows of the output matrix further comprises: scaling up the estimated mean row size by a factor that is greater than one; determining a size of the memory space based on the scaled-up estimated mean row size and the total number of rows of the output matrix; and allocating the memory space based on the determined size from the RAM.

In some embodiments, the method 600 may further include allocating an array of pointers respectively corresponding to the rows of the output matrix, wherein the array of pointers are initialized. In some embodiments, the method 600 may further include detecting, during the spGEMM, that the estimated mean row size is insufficient to store non-zero data of a row in the output matrix; dynamically allocating an additional memory space corresponding to the row; and redirecting or updating one of the array of pointers corresponding to the row to point to the dynamically allocated additional memory space.

In some embodiments, the method 600 may further include performing the spGEMM between non-zero data of the first sparse matrix and non-zero data of the second sparse matrix, wherein a multiplication between a first non-zero data from the first sparse matrix and a second non-zero data from the second sparse matrix generates one output value; determining a memory location in the allocated memory space for storing the output value based on indices of the first non-zero data and the second non-zero data; and storing the output value in the allocated memory space at the determined memory location. In some embodiments, the determining the memory location for storing the output value comprises: determining a row index of the output value based on a row index of the first non-zero data; determining a column index of the output value based on a column index of the second non-zero data; and determining the memory location based on the row index of the output value and the column index of the output value.

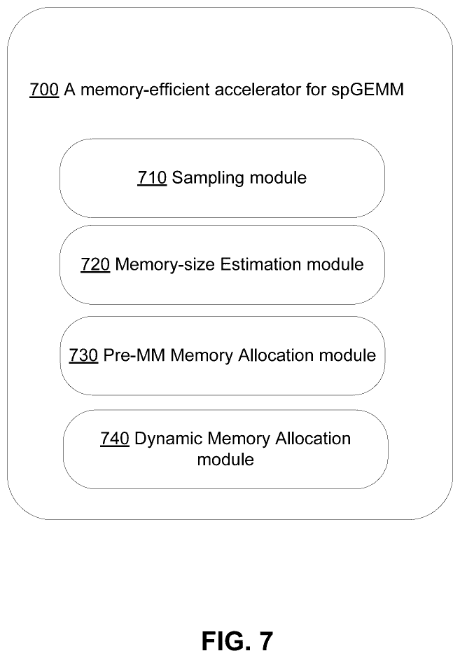

FIG. 7 illustrates an exemplary block diagram of a hardware device 700 with built-in efficient memory allocation for spGEMM in accordance with some embodiments. The components of the hardware device 700 presented below are intended to be illustrative. Depending on the implementation, the hardware device 700 may include additional, fewer, or alternative components.

The hardware device 700 may be an example of implementing the method 600 of FIG. 6 for performing spGEMM between a first sparse matrix and a second sparse matrix. The hardware device 700 may include one or more processors and one or more non-transitory computer-readable storage media (e.g., one or more memories) coupled to the one or more processors and configured with instructions executable by the one or more processors to cause the system or device (e.g., the processor) to perform the above-described embodiments. The hardware device 700 may include various units/modules corresponding to the instructions (e.g., software instructions). In some embodiments, the hardware device 700 may include a device, apparatus, system, circuitry, or module illustrated by FIGS. 1-5, such as the memory management circuitry 230 in FIG. 1. The hardware device 700 may be implemented as part of a processing unit such as a CPU or GPU, or as a separate hardware accelerator.

In some embodiments, the hardware device 700 may include a sampling module 710, a memory-size estimation module 720, a pre-MM (matrix multiplication) memory allocation module 730, and a dynamic memory allocation module 740.

In some embodiments, the sampling module 710 may be configured to sample a plurality of first rows in the first sparse matrix, and identify a plurality of second rows in the second sparse matrix based on indices of non-zero data in the plurality of sampled first rows. In some embodiments, the sampling module 710 may be similar to the sampling module 232 of FIG. 1. In some embodiments, the sampling module 710 may be configured to perform one or more steps described in block 620 of FIG. 6.

In some embodiments, the memory-size estimation module 720 may be configured to perform multiplication operations between the non-zero data in the plurality of first rows and non-zero data in the plurality of second rows, determine an estimated compression ratio of the output matrix based on the multiplication operations, and determine an estimated mean row size for storing non-zero data of each row in the output matrix based on the estimated compression ratio.

In some embodiments, the pre-MM memory allocation module 730 may be configured to allocate, through a system call according to the estimated mean row size and a total number of rows of the output matrix, a memory space in a hardware memory for storing the output matrix before performing the spGEMM between the first sparse matrix and the second sparse matrix.

In some embodiments, the dynamic memory allocation module 740 may be configured to allocate an array of pointers respectively corresponding to the rows of the output matrix, wherein the array of pointers are initialized. The array of pointers may be used in the following way: detecting, during the spGEMM, that the estimated mean row size is insufficient to store non-zero data of a row in the output matrix; dynamically allocating an additional memory space corresponding to the row; and updating one of the array of pointers corresponding to the row to point to the dynamically allocated additional memory space.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may include program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code that include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for memory allocation in performing sparse matrix-matrix multiplications (spGEMM), comprising:
obtaining a first sparse matrix and a second sparse matrix for performing spGEMM between the first sparse matrix and the second sparse matrix;
sampling a plurality of first rows in the first sparse matrix;
identifying, based on indices of non-zero data in the plurality of first rows, a plurality of second rows in a second sparse matrix;
performing symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows;
determining an estimated compression ratio of the spGEMM's output matrix based on the sampled NNZ and the sampled FLOP;
determining an estimated mean row size for storing non-zero data of each row in the output matrix based at least on the estimated compression ratio and an estimated total number of floating point multiplication operations (overall FLOP); and
allocating, according to the estimated mean row size, a memory space in a hardware memory for storing the output matrix before performing the spGEMM.

2. The method of claim 1, wherein the performing symbolic multiplication operations between the non-zero data in the plurality of first rows and non-zero data in the plurality of second rows comprises:
performing a first symbolic multiplication to obtain the sampled NNZ in the hypothetical product of the plurality of first rows and the plurality of second rows; and
performing a second symbolic multiplication to obtain the sampled FLOP in the hypothetical product of the plurality of first rows and the plurality of second rows,
wherein the first symbolic multiplication and the second symbolic multiplication are performed based on index information of the plurality of first rows and the plurality of second rows, and
in comparison to the second symbolic multiplication, the first symbolic multiplication comprises an additional column index deduplication step.

3. The method of claim 1, further comprising:
allocating an array of pointers respectively corresponding to the rows of the output matrix.

4. The method of claim 3, further comprising:
detecting, during the spGEMM, that the estimated mean row size is insufficient to store non-zero data of a row in the output matrix;
dynamically allocating an additional memory space corresponding to the row; and
updating one of the array of pointers corresponding to the row to point to the dynamically allocated additional memory space.

5. The method of claim 1, further comprising:
performing the spGEMM between non-zero data of the first sparse matrix and non-zero data of the second sparse matrix, wherein a multiplication between a first non-zero data from the first sparse matrix and a second non-zero data from the second sparse matrix generates one output value;
determining a memory location in the allocated memory space for storing the output value based on indices of the first non-zero data and the second non-zero data; and
storing the output value in the allocated memory space at the determined memory location.

6. The method of claim 5, wherein the determining the memory location for storing the output value comprises:
determining a row index of the output value based on a row index of the first non-zero data;
determining a column index of the output value based on a column index of the second non-zero data; and
determining the memory location based on the row index of the output value and the column index of the output value.

7. The method of claim 1, wherein the identifying the plurality of second rows in the second sparse matrix based on the indices of the non-zero data in the plurality of first rows comprises:
for each of the non-zero data in the plurality of first rows, identifying a second row in the second sparse matrix with a row index equal to a column index of the each non-zero data.

8. The method of claim 1, wherein the obtaining the first sparse matrix and the second sparse matrix comprises:
reading non-zero data of the first and second sparse matrix stored in a compressed sparse row (CSR) format.

9. The method of claim 2, wherein the performing the first symbolic multiplication to obtain the sampled NNZ comprises:
for each first row in the plurality of first rows, retrieving index information of non-zero data in one or more of the plurality of second rows that correspond to the first row;
iterating column indices of the non-zero data in one or more second rows based on the retrieved index information;
inputting the column indices into a data structure for detecting duplicated column indices and obtaining a number of unique column indices; and
accumulating the number of unique column indices to obtain the sampled NNZ.

10. The method of claim 2, wherein the performing the second symbolic multiplication to obtain the sampled FLOP comprises:
for each first row in the plurality of first rows, retrieving index information of non-zero data in one or more of the plurality of second rows that correspond to the first row;
determining a number of indices in the one or more second rows based on the index information, wherein each of the indices corresponds to a non-zero data; and
accumulating the number of indices to obtain the sampled FLOP.

11. The method of claim 1, wherein the determining the estimated mean row size for storing each row of the output matrix comprises:
performing a symbolic multiplication between the first sparse matrix and the second sparse matrix to obtain the overall FLOP based on index information of the first sparse matrix and the second sparse matrix;
determining a number of rows of the output matrix;
determining the estimated mean row size for storing each row of the output matrix based on (1) the overall FLOP, (2) the number of rows of the output matrix, and (3) the estimated compression ratio.

12. The method of claim 1, wherein the hardware memory comprises a random-access memory (RAM) of a computer system, and
the allocating the memory space in a hardware memory according to the estimated mean row size and the total number of rows of the output matrix further comprises:
scaling up the estimated mean row size by a factor that is greater than one;
determining a size of the memory space based on the scaled-up estimated mean row size and the total number of rows of the output matrix; and
allocating the memory space based on the determined size from the RAM.

13. An sparse matrix-matrix multiplications (spGEMM) accelerator for memory allocation in performing spGEMM between a first sparse matrix and a second sparse matrix, comprising:
a sampling circuitry configured to:
sample a plurality of first rows in the first sparse matrix, and
identify a plurality of second rows in the second sparse matrix based on indices of non-zero data in the plurality of sampled first rows;
a memory-size estimation circuitry configured to:
perform symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows,
determine an estimated compression ratio of the output matrix based on the sampled NNZ and the sampled FLOP, and
determine an estimated mean row size for storing non-zero data of each row in the output matrix based at least on the estimated compression ratio and an estimated total number of floating point multiplication operations (overall FLOP); and
a memory management circuitry configured to:
allocate, according to the estimated mean row size, a memory space in a hardware memory for storing the output matrix before performing the spGEMM.

14. The spGEMM accelerator of claim 13, wherein the multiplication operations between the non-zero data in the plurality of first rows and non-zero data in the plurality of second rows comprise:
a first symbolic multiplication that computes the sampled NNZ in the hypothetical product of the plurality of first rows and the plurality of second rows, and
a second symbolic multiplication that computes the sampled FLOP in the hypothetical product of the plurality of first rows and the plurality of second rows,
wherein the first symbolic multiplication and the second symbolic multiplication are performed based on index information of the plurality of first rows and the plurality of second rows, and
in comparison to the second symbolic multiplication, the first symbolic multiplication comprises an additional column index deduplication step.

15. The spGEMM accelerator of claim 13, wherein the memory management circuitry is further configured to:
allocate an array of pointers respectively corresponding to the rows of the output matrix.

16. The spGEMM accelerator of claim 15, wherein the memory management circuitry is further configured to:
during spGEMM, detect that the estimated mean row size is insufficient to store non-zero data of a row in the output matrix;
dynamically allocate an additional memory space corresponding to the row; and
update one of the array of pointers corresponding to the row to point to the dynamically allocated additional memory space.

17. The spGEMM accelerator of claim 15, wherein the hardware memory comprises a random-access memory of a computer system, and
the memory management circuitry is further configured to:
scaling up the estimated mean row size by a factor that is greater than one;
determining a size of the memory space based on the scaled-up estimated mean row size and the total number of rows of the output matrix; and
allocating the memory space based on the determined size from the RAM.

18. A non-transitory computer-readable storage medium for memory allocation in executing sparse matrix-matrix multiplications (spGEMM) between a first sparse matrix and a second sparse matrix, the storage medium storing instructions that, when executed by one or more processors, cause the one or more processors to perform operations comprising:
sampling a plurality of first rows in the first sparse matrix;
identifying, based on indices of non-zero data in the plurality of first rows, a plurality of second rows in a second sparse matrix;
performing symbolic multiplication operations between the plurality of first rows and the plurality of second rows to obtain (1) an estimated number of non-zero output data (sampled NNZ) and (2) an estimated number of floating point multiplication operations (sampled FLOP) in a hypothetical product of the plurality of first rows and the plurality of second rows;
determining an estimated compression ratio of the spGEMM's output matrix based on the sampled NNZ and the sampled FLOP;
determining an estimated mean row size for storing non-zero data of each row in the output matrix based at least on the estimated compression ratio and an estimated total number of floating point multiplication operations (overall FLOP); and
allocating, according to the estimated mean row size, a memory space in a hardware memory for storing the output matrix before performing the spGEMM.

19. The non-transitory computer-readable storage medium of claim 18, wherein the performing symbolic multiplication operations between the non-zero data in the plurality of first rows and non-zero data in the plurality of second rows comprises:
performing a first symbolic multiplication to obtain the sampled NNZ in the hypothetical product of the plurality of first rows and the plurality of second rows; and
performing a second symbolic multiplication to obtain the sampled FLOP in the hypothetical product of the plurality of first rows and the plurality of second rows,
wherein the first symbolic multiplication and the second symbolic multiplication are performed based on index information of the plurality of first rows and the plurality of second rows, and
in comparison to the second symbolic multiplication, the first symbolic multiplication comprises an additional column index deduplication step.

20. The non-transitory computer-readable storage medium of claim 18, wherein the operations further comprise:
allocating an array of pointers respectively corresponding to the rows of the output matrix, wherein the array of pointers are initialized.
